(19) United States
(12) Patent Application Publication
(10) Pub. No.: US 2023/0087172 A1
(43) Pub. Date: Mar. 23, 2023

(54) HELMET PROJECTOR SYSTEM FOR VIRTUAL DISPLAY

(71) Applicant: Hypergiant Industries, Inc., Austin, TX (US)

(72) Inventors: Benjamin Edward Lamm, Dallas, TX (US); Andrew Thomas Busey, Austin, TX (US); Daniel David Haab, Austin, TX (US); Davis Michael Saltzgiver, Austin, TX (US); Christopher T. Cotton, Honeoye Falls, NY (US); Marc Allen Boudria, Austin, TX (US)

(21) Appl. No.: 17/446,178

(22) Filed: Aug. 27, 2021

Related U.S. Application Data
(60) Provisional application No. 63/071,662, filed on Aug. 28, 2020.

(51) Int. Cl. G02B 27/01

(52) U.S. Cl. CPC G02B 27/0172; G02B 2027/0174; G02B 2027/011

(57) ABSTRACT

Systems and methods for providing a head-up display using a holographic element formed on a visor of a wearable element (e.g., a helmet) are disclosed. Light projectors along with corresponding optics are positioned on both sides of a user's head within the wearable element. Light from a light projector is directed towards the holographic element to reflect towards the eye on the opposite side of the head from the light projector. With light reflecting from both light projectors, images are perceived by the user is being positioned on a virtual screen where the virtual screen is positioned outside the wearable element. Images on the virtual screen are displayed stereoscopically and with a large field of view for the user.

### PRIORITY CLAIM

This Application claims priority to U.S. Provisional Patent Application 63/071,662, filed Aug. 28, 2020, and which is hereby incorporated by reference in its entirety.

### BACKGROUND

### 1. Field of the Invention

The present disclosure relates generally to devices for projecting displays in a user's field of view. More particularly, embodiments disclosed herein relate to devices wearable on a person's head, such as helmets, that provide a virtual image viewable in the user's field of view.

### 2. Description of Related Art

Enhanced helmet display requirements, for example, those generated by the National Aeronautics and Space Administration (NASA) and other entities, have been imposed on the next generation of space suits suitable for extra-vehicular activity (EVA). Some non-limiting examples of the new requirements include full color graphical displays that provide continually updated data such as procedures, checklists, photo imagery, and video. Current space suits that are suitable for extra-vehicular activity (EVA) generally utilize small one line, 12-character alpha-numeric display panels located on the external surface of the space suit, often in the chest or trunk area, and display a limited set of suit system data. Head-up displays (HUDs) may provide advanced display technologies for helmet-based display systems. There are some current helmet or eyewear mounted HUD systems that that enable users to view display data in detail. These current systems, however, are not suitable for use in space or aeronautical environments and the displays may be a hindrance to users of the systems.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a representation of an apparatus, according to some embodiments.

FIG. 2 depicts a top-view representation of a HUD system, according to some embodiments.

FIG. 3 depicts a perspective view representation of an optical projector system, according to some embodiments.

FIG. 4 depicts a cross-sectional side view representation of an optical projector system, according to some embodiments.

FIG. 5 depicts a side-view representation of a lens, according to some embodiments.

FIG. 6 depicts a side-view representation of another lens, according to some embodiments.

FIG. 7 depicts a side-view representation of a yet another lens, according to some embodiments.

FIG. 8 depicts a top-view representation of a HUD system showing possible light paths, according to some embodiments.

FIG. 9 depicts a straight-on view representation of a HUD system and possible light paths, according to some embodiments.

FIG. 10 depicts a representation of an eyebox, according to some embodiments.

FIG. 11 depicts a representation of an adjustable eyebox, according to some embodiments.

FIG. 12 depicts a block diagram of a HUD system, according to some embodiments.

FIG. 13 depicts a representation of a hologram recording system, according to some embodiments.

FIG. 14 is a flow diagram illustrating a method for displaying a head-up display, according to some embodiments.

FIG. 15 is a block diagram of one embodiment of a computing device.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Within this disclosure, different entities (which may variously be referred to as “units,” “mechanisms,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. A “controller configured to control a system” is intended to cover, for example, a controller that has circuitry that performs this function during operation, even if the controller in question is not currently being used (e.g., is not powered on). Thus, an entity described or recited as “configured to” perform some task refers to something physical, such as a device, circuit, memory storing program instructions executable to implement the task, etc. This phrase is not used herein to refer to something intangible.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” or “responsive to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

### DETAILED DESCRIPTION OF EMBODIMENTS

The present disclosure is directed to heads-up display (HUD) systems that provide a non-persistent HUD in the user's visible field of view. Current helmet or eye-wear mounted HUDs typically provide data displays that enable users to view reality in combination with the data. For example, a HUD may provide data to a user's normal field of view to allow the user to more readily access the data without having to look elsewhere (e.g., on a handheld or wearable device). While HUDs that provide data in the user's normal vision are useful in certain situations, there are situations where it may be beneficial to have the data removed from the user's field of view to provide the user a full field of view and remove distractions from the user's vision. For example, it may be useful in space or aeronautical environments where the user having a full field of view may be advantageous in certain situations, such as active stress situations. Further, in space and aeronautical environments, HUD systems need to be portable and lightweight with low energy consumption while being operable in the confined space and form-factor of a helmet worn by the user. HUDs for such environments may also benefit by providing bright and vivid displays on as clear a visor surface as possible, thereby providing optical transparency through the visor and clear vision of the user's immediate environment.

Various HUD systems have been contemplated for space and aeronautical environments. These systems are typically persistent systems that constantly project data on to a surface or screen positioned inside the helmet or use eyewear constantly worn by the user to generate the HUD. Thus, the HUD is constantly viewed by the user, which can be distracting, or the HUD blocks a portion of the user's view, thereby causing a blind spot in the user's vision.

A non-persistent HUD system provides the user with a data display in the field of view of the user while the system is active but removes the data display from the field of vision of the user when the HUD is not active (e.g., the user is provided a full field of view when the HUD is not in use). Additionally, it may be beneficial for the data display to not impede the user's close-in field of view when the HUD is active. Thus, the HUD system may project the data display on a surface that is perceived by the user as being at a distance that extends beyond the form-factor of the helmet worn by the user. For example, the data display may be perceived by the user to be outside the form-factor of the helmet (such as at an arm's length). Placing the perceived data display outside the form-factor of the helmet allows the user to have a greater field of view in close-in areas around the helmet during active use of the HUD.

The present disclosure contemplates a non-persistent HUD system that implements a binocular projector system in combination with a holographic element on the visor of a helmet to provide a data display in the user's field of view. Non-persistent HUDs may be especially useful in space and aeronautical environments but can also be applied in any environment where enhancing the vision of the user is important. The term “holographic element” is used herein to refer to a holographic element that forms images (e.g., recorded 3D images or shapes) by diffraction of a portion of the light that is incident on the holographic element. In certain instances, the diffraction of the light causes a non-specular reflection of light off the holographic element of one or more selected wavelengths from a light projector while allowing transmission of light at other wavelengths through the holographic element. For example, in one embodiment, a holographic element may non-specularly reflect light at a green wavelength while allowing other color wavelengths to transmit through the element. In some instances, the holographic element may be referred to as an element for forming a transmission hologram. Examples of holographic elements include, but are not limited to, a holographic film, a reflective coating, a holographic emulsion, or a grating.

One embodiment disclosed herein has four broad elements: 1) a curved visor on a helmet, 2) a holographic element on the surface of the curved visor, 3) a light projector positioned on a side of the head inside the helmet, and 4) an optical assembly coupled to the light projector that directs light from the light projector towards the holographic element. In some embodiments described herein, the optical assembly includes a set of lenses arranged to direct light from the light projector towards the holographic element and generate images in combination with the holographic element. The images generated in combination with the holographic element may be viewed by the user's eye on the opposite side of the head from the light projector. In certain embodiments, the images generated in combination with the holographic element are perceived by the eye on the opposite side of the head as being positioned at a distance outside the helmet (beyond the curved visor). For example, the images may be perceived by the user as being on a virtual screen at some distance outside the helmet. In some embodiments, the distance of the virtual screen is approximately an arm's length. The image on the virtual screen may also be larger than the area of light incident on the holographic element.

In some embodiments, two light projectors are positioned inside the helmet. A first light projector on one side of the head and a second light projector on the other side of the head. Optical assemblies are coupled to the first light projector and the second light projector to direct light from the projectors towards the holographic element on the curved visor. The first light projector and its corresponding optical assembly direct light to generate first images that are viewed by the eye on the opposite side of the head from the first light projector while the second light projector and its corresponding optical assembly direct light to generate second images that are viewed by the eye on the opposite side of the head from the second light projector. In certain embodiments, the first and second images are combined with the holographic element to generate a stereoscopic image where the stereographic image is perceived by the user as being located on the virtual screen. In some embodiments, the stereographic image is a three-dimensional image generated by overlap of the first and second images.

In various embodiments, the light projectors are able to be turned on/off on a controlled basis. Turning on/off the light projectors enables the display to operate as a non-persistent display in the user's field of view. Use of the holographic element to display the images allows for fast response time to turning on/off the projectors. When the projectors are turned off, the holographic element is substantially transparent to optical transmission such that the visor appears as clear as possible to the user.

In short, the present inventors have recognized that arranging light projection in combination with a holographic element provides advantages suitable for non-persistent operation of a HUD in a space or aeronautical environment. This approach advantageously provides a user wearing a helmet (e.g., a space helmet) with as large a field of view as possible when the HUD is inactive. During active periods, the HUD is perceived by the user at a distance (e.g., an arm's length) to advantageously position the HUD away from the user's immediate vision. In addition, this approach advantageously provides a system with a high visibility HUD but low power consumption that is contained within a form-factor of the helmet.

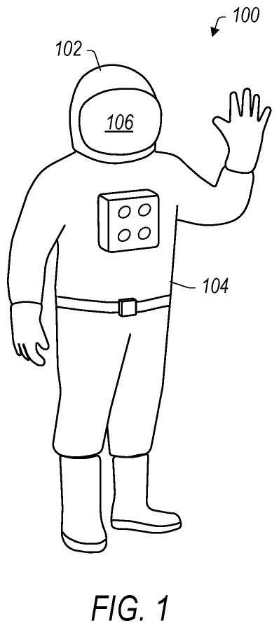

FIG. 1 depicts a representation of apparatus 100, according to some embodiments. Apparatus 100 includes wearable element 102. Wearable element 102 may be, for example, a helmet that that is attachable to suit 104. Wearable element 102 and suit 104 may be suitable for use in a space or aeronautical environment. When attached, wearable element 102 and suit 104 may provide a substantially sealed, breathable environment for the user (e.g., astronaut) inside apparatus 100. For example, wearable element 102 may provide a pressurized, oxygen-rich atmospheric bubble to protect the user's head when attached to suit 104.

In certain embodiments, wearable element 102 includes visor 106. Visor 106 may be secured, attached, or coupled to wearable element 102 by any one of numerous known technologies. Visor 106 may provide a field of view for the user (e.g., astronaut) using apparatus 100. Visor 106 may include transparent portions or semi-transparent portions that permit the user to look outside of the helmet. The transparent or semi-transparent portions may also reduce certain wavelengths of light produced by glare and/or reflection from entering the user's eyes. One or more portions of the visor 106 may be interchangeable. For example, transparent portions may be interchangeable with semi-transparent portions. In some embodiments, visor 106 includes elements or portions that are pivotally attached to wearable element 102 to allow the visor elements to be raised and lowered from in front of the user's field of view.

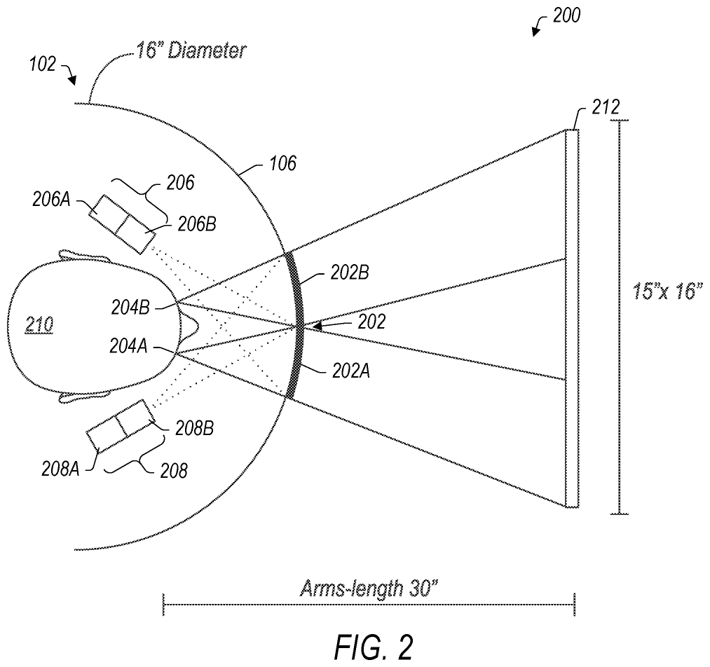

FIG. 2 depicts a top-view representation of HUD system 200, according to some embodiments. HUD system 200 includes visor 106 from wearable element 102 along with first projector system 206 and second projector system 208 positioned inside the wearable element. In certain embodiments, visor 106 is a curved (e.g., spherical) visor. In one embodiment, visor 106 has a spherical diameter of about 16 inches. The spherical diameter or shape of visor 106 may vary based on desired properties of HUD system 200 or desired properties in wearable element 102.

In certain embodiments, HUD system 200 includes holographic element 202 formed on visor 106. In the illustrated embodiment, holographic element 202 is shown on a portion of visor 106 directly in front of the user's eyes 204. Holographic element 202 may, however, be formed on different sized portions of visor 106. For example, holographic element 202 may be formed on an entire surface of visor 106. In some embodiments, holographic element 202 is a holographic surface on visor 106. In certain embodiments, holographic element 202 is a holographic emulsion (e.g., a film or gelatin formed of a mixture of two or more immiscible liquids). Deposition of holographic element 202 on visor 106 may be performed using methods known in the art. For example, holographic element 202 may be spin coated on visor 106.

HUD system 200 further includes first optical projector system 206 and second optical projector system 208. In certain embodiments, as illustrated in FIG. 2, first optical projector system 206 is positioned on one side of the user's head 210 while second optical projector system 208 is positioned on the opposite side of the user's head. First optical projector system 206 includes first light projector 206A and first optical assembly 206B. Second optical projector system 208 includes second light projector 208A and second optical assembly 208B.

In certain embodiments, first light projector 206A and second light projector 208A are digital light projectors (DLPs). For example, first light projector 206A and second light projector 208A may be LED projectors. In some contemplated embodiments, first light projector 206A and second light projector 208A are laser projectors. First light projector 206A and second light projector 208A may be capable of providing light at one or more selected wavelengths. The light projectors may be chosen to provide the selected wavelength(s) or be tunable to the selected wavelength(s). In one embodiment, first light projector 206A and second light projector 208A provide light at a wavelength of 532 nm (e.g., green light). In such an embodiment, images perceived by the user will be viewed as green light images. Embodiments may also be contemplated where first light projector 206A and second light projector 208A provide light at different wavelengths, over a partial color range, or over a full color range of visible wavelengths.

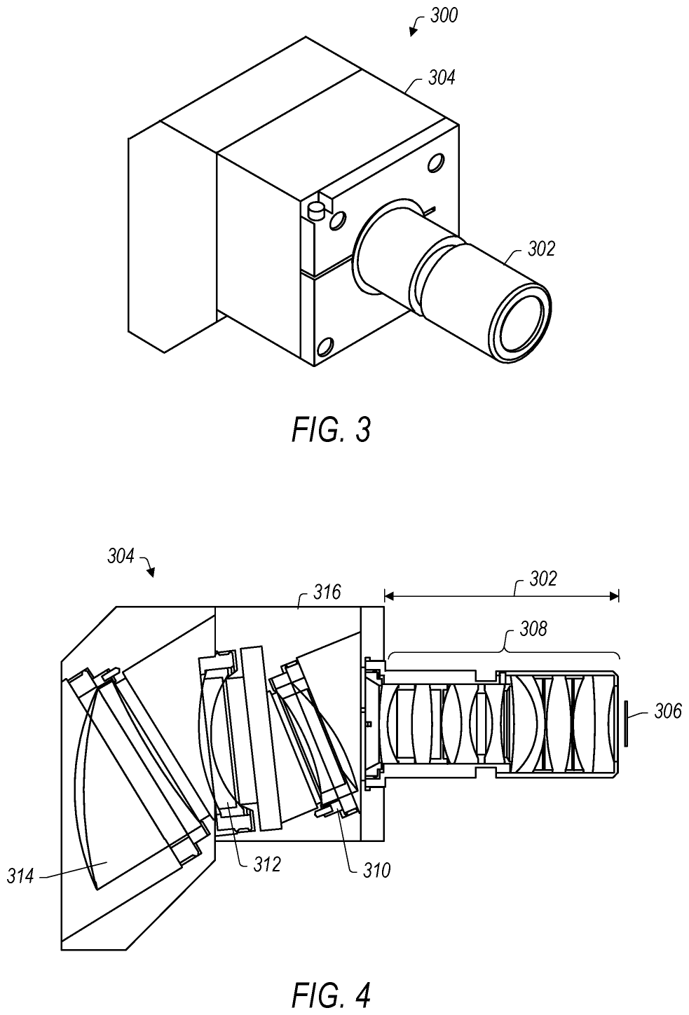

FIG. 3 depicts a perspective view representation of an optical projector system, according to some embodiments. Optical projector system 300 may correspond to either first optical projector system 206 or second optical projector system 208, shown in FIG. 2. In the illustrated embodiment, optical projector system 300 includes light projector 302 and optical assembly 304. FIG. 4 depicts a cross-sectional side view representation of optical projector system 300, according to some embodiments. As shown in FIG. 4, light projector 302 includes light source 306 coupled to optical elements 308. In certain embodiments, light source 306 is an LED light source such that light projector 302 is an LED light projector. One example of an LED light source is a Texas Instruments DLP3010 projector. Optical elements 308 may be, for example, a series of optical elements to focus and tune light. Examples of optical elements include, but are not limited to, lenses, diffractive elements, and aberration correctors. Light from light source 306 passes through optical elements 308 and into optical assembly 304.

In embodiments where light projector 302 is an LED light projector, optical assembly 304 includes one or more lenses. The lenses in optical assembly 304 may correct aberrations in light from light projector 302 and focus light towards the holographic element (shown in FIG. 2). In the illustrated embodiment, optical assembly includes three lenses—lens 310, lens 312, and lens 314—inside lens body 316. In some embodiments, lens 310, lens 312, and lens 314 are polymeric lenses (such as cycloolefin polymer (COP) lenses or acrylic lenses) or glass lenses (such as Schott NF-2 lenses).

In certain embodiments, lens 310, lens 312, and lens 314 have optical properties and are arranged with respect to each other to provide defined properties in the light output from optical assembly 304. Providing the selected properties may include correcting aberrations from the light passing through optical assembly 304 such that distortions in the image displayed in combination with holographic element 202 are removed. In some embodiments, lens 310, lens 312, and lens 314 may provide the defined properties by having one or more surfaces with defined radii of curvature (sphere radii) or one or more surfaces with defined radii of curvature in combination with Zernike coefficients.

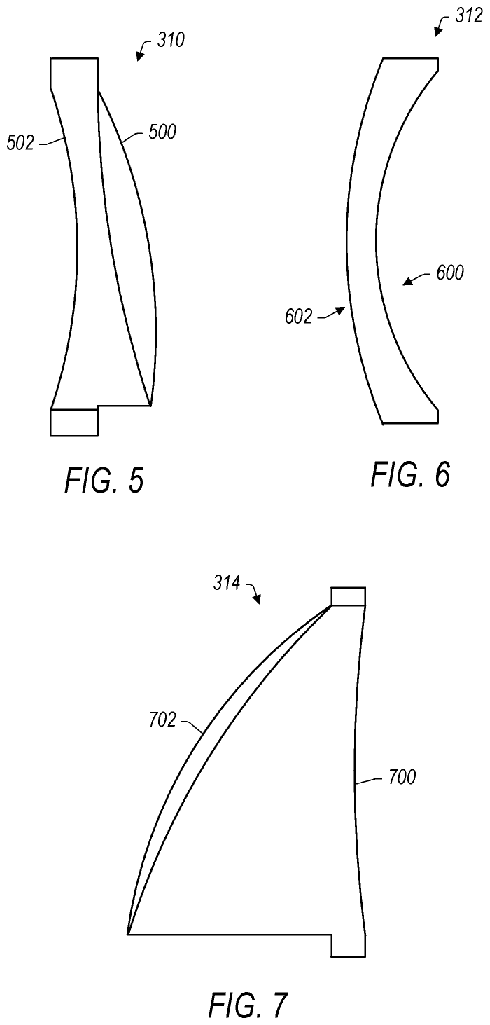

FIG. 5 depicts a side-view representation of lens 310, according to some embodiments. Lens 310 includes right surface 500 and left surface 502. In some embodiments, lens 310 is a polymeric lens (e.g., a COP lens). In the illustrated embodiment, right surface 500 has a defined radius of curvature for a convex surface and a defined Zernike coefficient. Left surface 502 has a defined radius of curvature for a concave surface.

FIG. 6 depicts a side-view representation of lens 312, according to some embodiments. Lens 312 includes right surface 600 and left surface 602. In some embodiments, lens 312 is a glass lens (e.g., an NF-2 lens). In the illustrated embodiment, right surface 600 has a defined radius of curvature for a concave surface. Left surface 602 has a defined radius of curvature for a convex surface.

FIG. 7 depicts a side-view representation of lens 314, according to some embodiments. Lens 314 includes right surface 700 and left surface 702. In some embodiments, lens 314 is a polymeric lens (e.g., an acrylic lens). In the illustrated embodiment, right surface 700 has a defined radius of curvature for a concave surface. Left surface 702 has a defined radius of curvature for a convex surface and defined Zernike coefficients.

Returning to FIG. 4, optical assembly 304 has defined optical properties in lenses 310, 312, and 314 to provide LED light output from the optical assembly with defined properties. In embodiments where optical assembly 304 includes a laser light source (as described above), optical assembly 304 may include one or more waveguides to define properties in the light output and correct aberrations in the light output.

Optical assembly 304 may be implemented as first optical assembly 206B and second optical assembly 208B, shown in FIG. 2. Accordingly, first optical assembly 206B and second optical assembly 208B have defined optical properties to provide defined properties in the light output directed towards holographic element 202. In the illustrated embodiment, holographic element 202 includes first portion 202A and second portion 202B. First portion 202A may be aligned with first optical assembly 206B and first eye 204A. Similarly, second portion 202B may be aligned with second optical assembly 208B and second eye 204B.

In certain embodiments, first optical assembly 206B is arranged with respect to first portion 202A of holographic element 202 on visor 106 such that the light output from the first optical assembly generates an image in combination with the first portion of the holographic element. The image formed in combination with first portion 202A may be perceived by first eye 204A as being positioned on virtual screen 212. Similarly, second optical assembly 208B is arranged with respect to second portion 202B of holographic element 202 on visor 106 such that the light output from the second optical assembly generates an image in combination with the second portion of the holographic element. The image formed in combination with second portion 202B may be perceived by second eye 204B as also being positioned on virtual screen 212. As shown in FIG. 2, virtual screen 212 is at a distance from eyes 204 that is greater than the distance of holographic element 202 from the eyes.

In certain embodiments, first optical assembly 206B and second optical assembly 208B are arranged with respect to holographic element 202 based on the distance between eyes 204 and the holographic element and a shape of visor 106 (e.g., the curvature of the visor). The shape of visor 106 determines the shape of holographic element 202. The arrangement of holographic element 202 with respect to the optical assemblies and the shape of the holographic element reflects the light to eyes 204 in a way that the eyes perceive the light as being on a different shaped surface (e.g., virtual screen 212). Thus, the properties of first optical assembly 206B and second optical assembly 208B may be defined based on the arrangement of the optical assemblies with respect to holographic element 202 and its shape to generate the images perceived by the user as being on virtual screen 212.

As described above, light directed towards first portion 202A of holographic element 202 by first optical assembly 206B generates images perceived by first eye 204A while light directed towards second portion 202B of the holographic element by second optical assembly 208B generates images perceived by second eye 204B. Thus, each optical assembly provides light that reflects off holographic element 202 towards its corresponding eye. In the illustrated embodiment, first portion 202A overlaps with second portion 204B. This overlap generates images perceived by first eye 204A and second eye 204B to be overlapping.

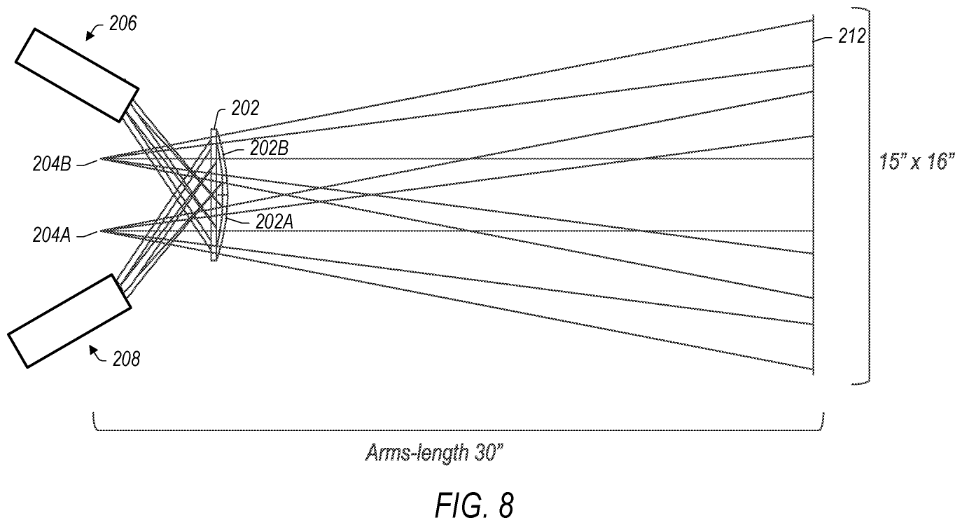

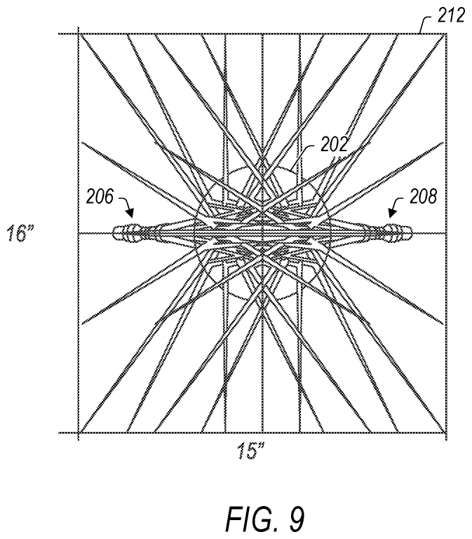

FIG. 8 depicts a top-view representation of HUD system 200 showing possible light paths, according to some embodiments. In FIG. 8, first eye 204A and second eye 204B are shown as points and the head and visor are not shown for clarity. FIG. 9 depicts a straight-on view representation of HUD system 200 and possible light paths shown from behind first optical projector system 206 and second optical projector system 208, according to some embodiments. As shown in FIGS. 8 and 9, overlap in reflected light from holographic element 202 received by both first eye 204A and second eye 204B. The overlap in the reflected light generates the overlap in the images perceived by both first eye 204A and second eye 204B.

The overlap in the images perceived by first eye 204A and second eye 204B may be accounted for by a processor included in HUD system 200, described herein. In certain embodiments, the processor may generate images for projection by first optical projector system 206 and second optical projector system 208 that combine in combination with the holographic element to be perceived as a stereoscope image on virtual screen 212 by the user. In some embodiments, the images may overlap such that the stereoscopic image appears as a three-dimensional image. In some possible embodiments, only one optical assembly may be implemented to provide light reflected towards a single eye (e.g., first optical projector system 206 provides light reflected towards first eye 204A). In such embodiments, the user may perceive the image as a monocular image.

In certain embodiments, the images perceived by the user as being on virtual screen 212 are bigger and have a larger field of view than images directly viewed on the surface of visor 106 (e.g., on a normal reflective element or other display on the visor). The size and field of view of images on virtual screen 212 and the distance of the virtual screen may depend on the defined properties of first optical assembly 206B and second optical assembly 208B and the distance between eyes 204 and holographic element 202. In certain embodiments, holographic element 202 is at a distance of about 16 inches from eyes 204. In such embodiments, first optical assembly 206B and second optical assembly 208B may be arranged and have defined properties that place virtual screen 212 at a distance of about 30 inches (e.g., an arm's length) from eyes 204.

In the vertical direction, at the distance of about 30 inches, virtual screen 212 may have a field of view with a height of about 16 inches and a viewing angle of ±about 15° (e.g., a 30° total vertical viewing angle). In the horizontal direction, virtual screen 212 may have a field of view for a single eye with a width of about 12 inches and a viewing angle of ±about 11° (a 22° total horizontal viewing angle). Combining the field of view of both eyes with about a 16° overlap between the eyes may result in virtual screen 212 having a field of view with a width of about 15 inches and a total horizontal viewing angle of ±about 28°.

Embodiments may be contemplated where the distance between holographic element 202 and eyes 204 varies and the distance between virtual screen 212 and the eyes varies. For example, the distance between holographic element 202 and eyes 204 may vary between about 12 inches and about 20 inches while the distance between virtual screen 212 and the eyes may vary between about 24 inches and about 36 inches. The size and field of view of virtual screen 212 may be determined by the relative distances of holographic element 202 and virtual screen 212 from eyes 204.

Images on virtual screen 212 may be perceived by eyes 204 with a high resolution and defined brightness. The resolution and brightness may be determined by the relative distances of holographic element 202 and virtual screen 212 from eyes 204 and the defined properties of light output from first optical assembly 206B and second optical assembly 208B. For example, in one embodiment, images on virtual screen may have a resolution of at least about 880p×750p with a brightness of at least about 500 nits. Higher resolutions and greater brightness may be possible depending on the light source providing light and refining the optical properties of first optical assembly 206B and second optical assembly 208B. Brightness may also be adjustable by adjusting the light output (e.g., output power) of the light sources.

As described herein, first optical projector system 206 and second optical projector system 208 provide light onto holographic element 202 that is perceived by the user's eyes 204 as being position on virtual screen 212. In certain embodiments, first optical projector system 206 and second optical projector system 208 are calibrated to one or more properties of the user's eyes 204. Calibration of the projector systems may compensate for variances in the properties of eyes between different users. For example, eyeboxes for the projector systems may be calibrated to interpupillary distance between a specific user's eyes. An eyebox may be defined as a region for the user's eye in which the image on virtual screen 212 is perceived clearly. Thus, with the user's eyes positioned in the eyeboxes, the user will clearly perceive images on virtual screen 212.

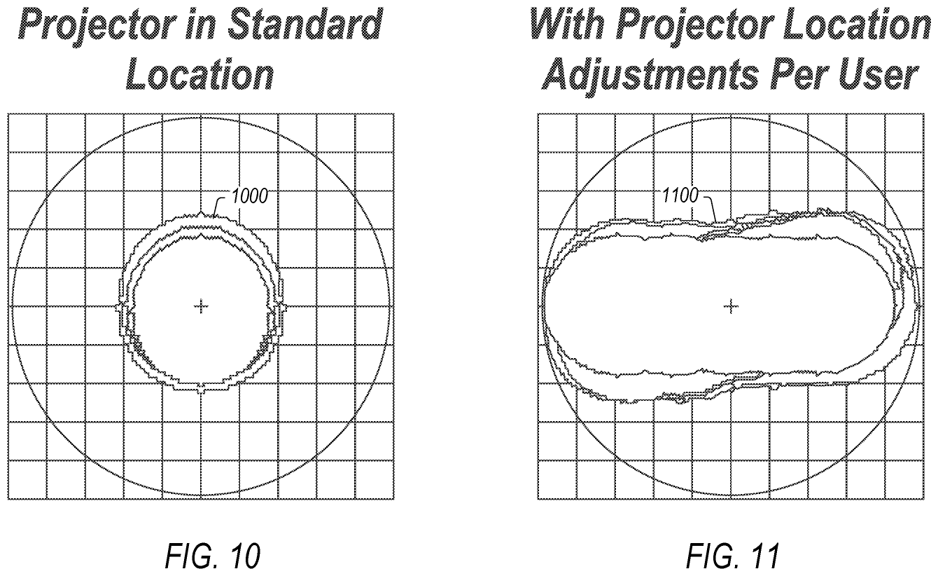

FIG. 10 depicts a representation of eyebox 1000, according to some embodiments. Generally, the smaller the size of eyebox 1000 for a particular optical projector, the larger the image on virtual screen 212 is perceived by the user. With an optical projector system (e.g., first optical projector system 206 or second optical projector system 208) in a standard position, eyebox 1000 may have a size of about 5 mm×5 mm for an eye. A typical human eye pupil has a diameter between about 2 mm and about 4 mm in bright light and between about 4 mm and about 8 mm in the dark. Thus, calibrating the location of eyebox 1000 to account for the distance between a specific user's eyes may provide a better experience for the user.

In some embodiments, first optical projector system 206 and second optical projector system 208 may include adjustable components to allow for adjusting to different users using HUD system 200. For example, first optical projector system 206 and second optical projector system 208 may be movable a small distance to make minor adjustments to the eyebox for different interpupillary distances. FIG. 11 depicts a representation of adjustable eyebox 1100, according to some embodiments. In the illustrated embodiment, eyebox 1100 is adjustable over a width of about 12 mm with a vertical height of about 5 mm. Having an adjustable width of about 12 mm may provide sufficient adjustability for differences in interpupillary distances between most users.

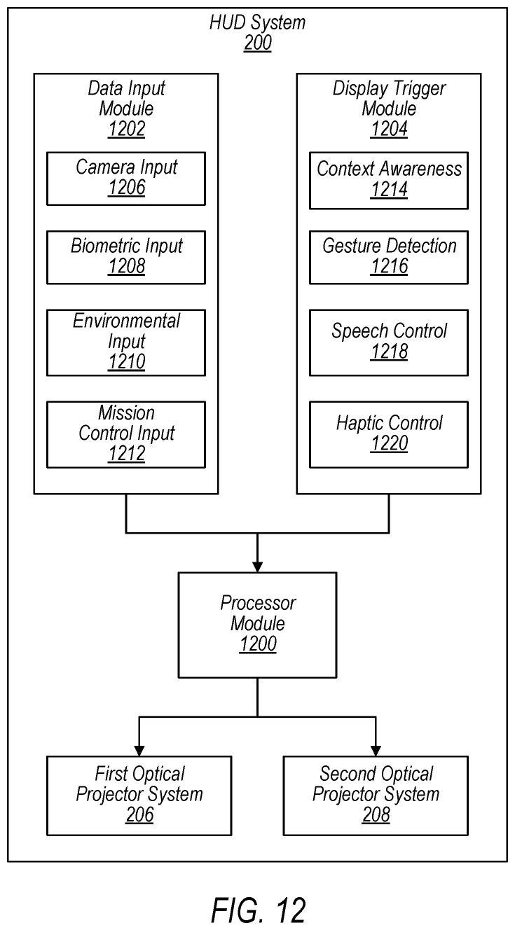

As described above, HUD system 200 may include a processor that generates images for display in the HUD system. FIG. 12 depicts a block diagram of HUD system 200, according to some embodiments. In the illustrated embodiment, HUD system 200 includes processor module 1200 coupled to first optical projector system 206 and second optical projector system 208. Processor module 1200 may generate images for projection by the optical projector systems, as described herein. In certain embodiments, HUD system 200 includes data input module 1202 and display trigger module 1204.

Data input module 1202 may receive data that is provided to processor 1200 for display in HUD system 200. Data input module 1202 may receive data via wired, wireless communication, or a combination thereof. Examples of data that may be received by data input module 1202 include, but are not limited to, camera input 1206, biometric input 1208, environmental input 1210, and mission control input 1212. Camera input 1206 may include, for example, input from one or more cameras coupled to apparatus 100 or wearable element 102. Biometric input 1208 may include input received from vital sign sensors, body position sensors, or body motion sensors coupled to apparatus 100 or wearable element 102. Vital sign sensors may include, but not be limited to, heart rate sensors, respiration rate sensors, and blood oxygen saturation (SpO2) sensors. Environmental input 1210 may include environmental information such as pressure, temperature, humidity, etc. Mission control input 1212 may include input receives from a remote mission control station or other remote system.

Display trigger module 1204 may determine whether the HUD generated by processor 1200 is turned on/off in HUD system 200 (e.g., whether first optical projector system 206 and second optical projector system 208 are turned on or turned off). Display trigger module 1204 may make determinations based on user input. User input may be provided using a variety of systems or modules on apparatus 100. For example, apparatus 100 may include context awareness devices 1214 that determine whether the apparatus (e.g., optical projector) is turned on/off based on the context of the user's situation. In some embodiments, gesture detection/recognition 1216 may be used to control on/off state of the HUD. An example of a gesture detection/recognition system is provided in U.S. patent application Ser. No. 16/748,469 to Busey et al., which is incorporated by reference as if fully set forth herein. Other examples of systems that may be used to control the on/off state of the HUD include, but are not limited to, speech control 1218 and haptic control 1220.

In certain embodiments, processor module 1200 generates images for display in HUD system 200 based on image data from recorded holograms. Image data associated with the recorded holograms may be stored in memory associated with processor module 1200 to provide data usable by the processor module to generate images for projection onto holographic element 202. In certain embodiments, holograms are recorded using a setup based on HUD system 200.

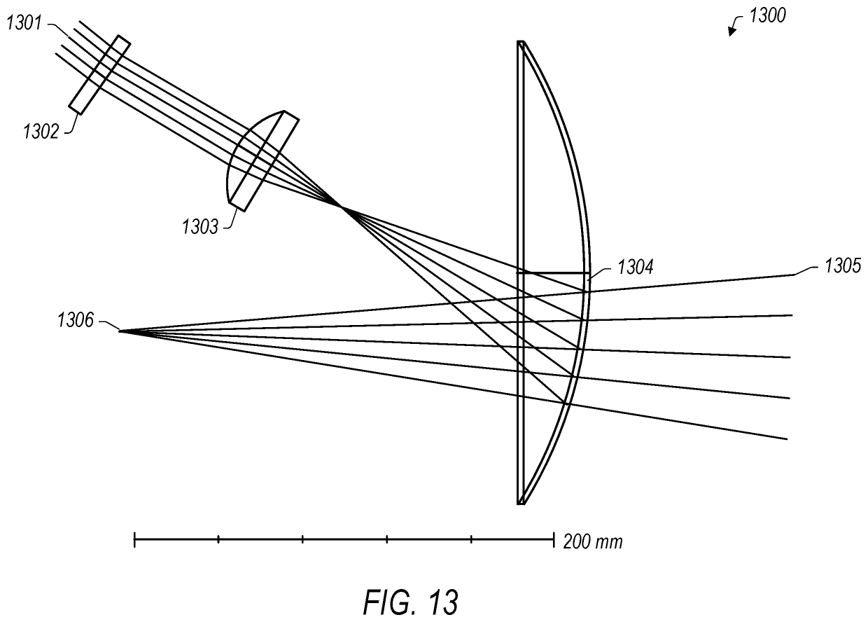

FIG. 13 depicts a representation of hologram recording system 1300, according to some embodiments. A possible recording configuration for HUD system 200 is shown. In the illustrated embodiment, recording medium 1304 records light transmitted by digitally produced hologram 1302 that is illuminated with collimated laser light 1301 and then focused by lens 1303 and is interfered with converging laser light 1305. Converging laser light 1305 is converging to point 1306. Recording medium 1304 may correspond to holographic element 202, described herein.

### Example Methods

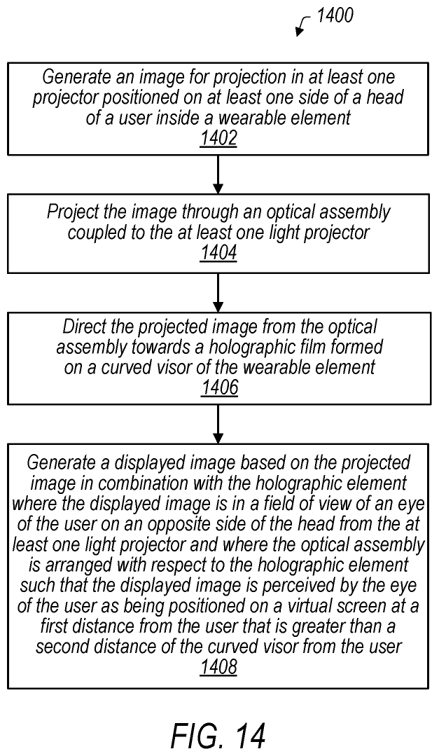

FIG. 14 is a flow diagram illustrating method 1400 for displaying a head-up display, according to some embodiments. The method shown in FIG. 14 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system.

At 1402, in the illustrated embodiment, an image for projection is generated in at least one projector positioned on at least one side of a head of a user inside a wearable element. In some embodiments, the image for projection is generated using a processor coupled to the at least one light projector.

At 1404, in the illustrated embodiment, the image is projected through an optical assembly coupled to the at least one light projector. In some embodiments, the optical assembly corrects aberrations in the projected image and removes distortions in the projected image.

At 1406, in the illustrated embodiment, the projected image is directed from the optical assembly towards a holographic element formed on a curved visor of the wearable element.

At 1408, in the illustrated embodiment, a displayed image is generated based on the projected image in combination with the holographic element where the displayed image is in a field of view of an eye of the user on an opposite side of the head from the at least one light projector and where the optical assembly is arranged with respect to the holographic element such that the displayed image is perceived by the eye of the user as being positioned on a virtual screen at a first distance from the user that is greater than a second distance of the curved visor from the user. In some embodiments, an eyebox for the eye is adjusted based on a position of the at least one projector relative to the eye.

### Example Computer System

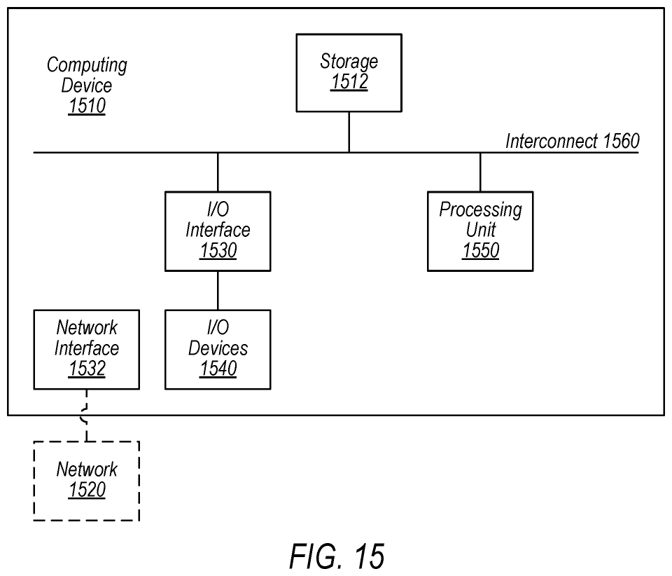

Turning now to FIG. 15, a block diagram of one embodiment of computing device (which may also be referred to as a computing system) 1510 is depicted. Computing device 1510 may be used to implement various portions of this disclosure. Computing device 1510 may be any suitable type of device, including, but not limited to, a personal computer system, desktop computer, laptop or notebook computer, mainframe computer system, web server, workstation, or network computer. As shown, computing device 1510 includes processing unit 1550, storage subsystem 1512, and input/output (I/O) interface 1530 coupled via an interconnect 1560 (e.g., a system bus). I/O interface 1530 may be coupled to one or more I/O devices 1540. Computing device 1510 further includes network interface 1532, which may be coupled to network 1520 for communications with, for example, other computing devices.

In various embodiments, processing unit 1550 includes one or more processors. In some embodiments, processing unit 1550 includes one or more coprocessor units. In some embodiments, multiple instances of processing unit 1550 may be coupled to interconnect 1560. Processing unit 1550 (or each processor within 1550) may contain a cache or other form of on-board memory. In some embodiments, processing unit 1550 may be implemented as a general-purpose processing unit, and in other embodiments it may be implemented as a special purpose processing unit (e.g., an ASIC). In general, computing device 1510 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage subsystem 1512 is usable by processing unit 1550 (e.g., to store instructions executable by and data used by processing unit 1550). Storage subsystem 1512 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 1512 may consist solely of volatile memory, in one embodiment. Storage subsystem 1512 may store program instructions executable by computing device 1510 using processing unit 1550, including program instructions executable to cause computing device 1510 to implement the various techniques disclosed herein.

I/O interface 1530 may represent one or more interfaces and may be any of various types of interfaces configured to couple to and communicate with other devices, according to various embodiments. In one embodiment, I/O interface 1530 is a bridge chip from a front-side to one or more back-side buses. I/O interface 1530 may be coupled to one or more I/O devices 1540 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a wearable element configured to be worn on a head of a user, wherein the wearable element includes:
a curved visor positioned at a first distance from the user in a field of view of the user when the user wears the wearable element on the head;
a holographic element formed on a surface of the curved visor;
at least one light projector positioned on at least one side of the head when the user wears the wearable element on the head; and
an optical assembly coupled to the at least one light projector, wherein the optical assembly is arranged to direct light from the at least one light projector towards the holographic element on the curved visor, the directed light generating images in combination with the holographic element, and wherein the optical assembly is arranged with respect to the holographic element such that the images generated in combination with the holographic element are perceived by an eye of the user on an opposite side of the head from the at least one light projector as being positioned on a virtual screen that is a second distance from the user in the field of view of the user, wherein the second distance is greater than the first distance.

2. The apparatus of claim 1, wherein the optical assembly and the holographic element are arranged based on the first distance and a shape of the curved visor to generate images on the virtual screen perceived by the eye of the user.

3. The apparatus of claim 1, wherein the images generated in combination with the holographic element are perceived by the eye of the user to be larger than an area of light from the at least one light projector incident on the holographic element.

4. The apparatus of claim 1, wherein the optical assembly includes a lens assembly with a plurality of lenses arranged to correct aberrations in light generated by the at least one projector and remove distortions in the images perceived by the eye of the user.

5. The apparatus of claim 1, wherein the holographic element is a holographic emulsion.

6. The apparatus of claim 1, wherein the first distance is between about 12 inches and about 20 inches and the second distance is between about 24 inches and about 36 inches.

7. The apparatus of claim 1, wherein the curved visor is transparent to light in a visible wavelength range.

8. The apparatus of claim 1, wherein an eyebox for the eye is adjustable based on a position of the at least one projector relative to the eye.

9. The apparatus of claim 1, further comprising:
at least one additional light projector positioned on a side of the head opposite the at least one light projector; and
an additional optical assembly coupled to the at least one additional light projector, wherein the additional optical assembly is arranged to direct light from the at least one additional light projector towards the holographic element on the curved visor, the directed light generating additional images in combination with the holographic element, and wherein the additional optical assembly is arranged with respect to the holographic element and the optical assembly such that the additional images generated in combination with the holographic element are perceived, in combination with the images from the at least one projector, by the eye of the user as stereographic images.

10. An apparatus, comprising:
a first optical assembly configured to be coupled to a first light projector, wherein the first optical assembly is configured to be arranged with the first light projector to direct light from the first light projector towards a first position on a curved holographic surface, and wherein the light from the first light projector is configured to generate a first image at the first position in combination with the curved holographic surface; and
a second optical assembly configured to be coupled to a second light projector, wherein the second optical assembly is configured to be arranged with the second light projector to direct light from the second light projector towards a second position on the curved holographic surface, and wherein the light from the second light projector is configured to generate a second image at the second position in combination with the curved holographic surface;
wherein a distance between the first position on the curved holographic surface and the first optical assembly is substantially equal to a distance between the second position on the curved holographic surface and the second optical assembly; and
wherein the first image and the second image are combined by the curved holographic surface to generate a stereoscopic image, and wherein the stereoscopic image is perceived by eyes of a user, the eyes being positioned between the first optical assembly and the second optical assembly, as being located on a virtual screen that is at a distance from the user that is further than a distance of the curved holographic surface from the user.

11. The apparatus of claim 10, wherein the first optical assembly includes three lenses arranged to correct aberrations in light generated by the first light projector, and wherein the second optical assembly includes three lenses arranged to correct aberrations in light generated by the second light projector.

12. The apparatus of claim 10, wherein the first optical assembly includes one or more waveguides arranged to correct aberrations in light generated by the first light projector, and wherein the second optical assembly includes one or more waveguides arranged to correct aberrations in light generated by the second light projector.

13. The apparatus of claim 10, wherein the curved holographic surface is a holographic element formed on a curved, optically transparent material.

14. The apparatus of claim 10, wherein the stereoscopic image is a three-dimensional image formed with at least some overlap between the first image and the second image.

15. A method, comprising:
generating an image for projection in at least one light projector positioned on at least one side of a head of a user inside a wearable element;
projecting the image through an optical assembly coupled to the at least one light projector;
directing the projected image from the optical assembly towards a holographic element formed on a curved visor of the wearable element; and
generating a displayed image based on the projected image in combination with the holographic element, wherein the displayed image is in a field of view of an eye of the user on an opposite side of the head from the at least one light projector, and wherein the optical assembly is arranged with respect to the holographic element such that the displayed image is perceived by the eye of the user as being positioned on a virtual screen at a first distance from the user that is greater than a second distance of the curved visor from the user.

16. The method of claim 15, further comprising correcting aberrations in the projected image and removing distortions in the displayed image with the optical assembly.

17. The method of claim 15, wherein the displayed image includes a heads-up display (HUD) image.

18. The method of claim 15, wherein the first distance is between about 12 inches and about 20 inches and the second distance is between about 24 inches and about 36 inches.

19. The method of claim 15, further comprising adjusting an eyebox for the eye based on a position of the at least one projector relative to the eye.

20. The method of claim 15, further comprising:
generating an additional image for projection in at least one additional light projector positioned on a side of the head opposite the at least one light projector;
projecting the additional image through an additional optical assembly coupled to the at least one additional light projector;
directing the projected additional image from the additional optical assembly towards the holographic element; and
generating an additional displayed image based on the additional projected image in combination with the holographic element, wherein the additional displayed image is displayed in combination with the displayed image in a field of view of the eye of the user, wherein the additional optical assembly is arranged with respect to the holographic element and the optical assembly such that the displayed image and the additional displayed image are perceived by the eye of the user as a stereographic image.
